(19) United States
(12) Patent Application Publication
(10) Pub. No.: US 2020/0112273 A1
(43) Pub. Date: Apr. 9, 2020

(54) MOTOR DRIVE DEVICE

(71) Applicant: FANUC CORPORATION, Yamanashi (JP)

(72) Inventors: Masaya TATEDA, Yamanashi (JP); Yasuyuki MATSUMOTO, Yamanashi (JP)

(73) Assignee: FANUC CORPORATION, Yamanashi (JP)

(21) Appl. No.: 16/556,008

(22) Filed: Aug. 29, 2019

(30) Foreign Application Priority Data
Oct. 4, 2018 (JP) 2018-189389

(51) Int. Cl. H02P 3/22

(52) U.S. Cl. CPC H02P 3/22; H02P 2201/03

(57) ABSTRACT

A motor drive device includes a converter, an inverter, a DC link capacitor, a dynamic braking circuit, current detectors, and an abnormality detector. The dynamic braking circuit includes a resistor and a switch provided between terminals of the motor, and performs braking of the motor by establishing the switch in an open state to disconnect between the terminals of the motor when driving the motor, and short-circuiting the terminals of the motor via the resistor with the switch in a closed state when stopping the motor. The current detectors detect the drive current of the motor. The abnormality detector detects, when driving the motor, abnormality of the dynamic braking circuit on the basis of the slope of the rise or fall of the drive current of the motor detected by the current detectors.

This application is based on and claims the benefit of priority from Japanese Patent Application No. 2018-189389, filed on 4 Oct., 2018, the content of which is incorporated herein by reference.

### BACKGROUND OF THE INVENTION

### Field of the Invention

The present invention relates to a motor drive device.

### Related Art

A motor drive device has been known which drives a motor used for a machine (equipment) such as machine tools, industrial machine, or robots. Such a motor drive device includes a dynamic braking circuit for stopping a motor promptly when stopping equipment (for example, refer to Japanese Unexamined Patent Application, Publication No. 2009-165296 or Japanese Unexamined Patent Application, Publication No. 2016-144232).

The dynamic braking circuit includes a resistor and a switch (for example, a b-contact electromagnetic contact-type relay (normally-closed: open when current flows in a coil)) provided between terminals of the motor. When the motor is driven, the dynamic braking circuit establishes the switch in an open state to disconnect between the terminals of the motor. On the contrary, when the equipment is stopped during the driving of the motor, the dynamic braking circuit sets the switch to be in a closed state to short-circuit the terminals of the motor via the resistor, and consumes, as heat, rotational energy of the motor, thereby performing braking of the motor.

Patent Document 1: Japanese Unexamined Patent Application, Publication No. 2009-165296
Patent Document 2: Japanese Unexamined Patent Application, Publication No. 2016-144232

### SUMMARY OF THE INVENTION

In a case where a dynamic braking circuit is activated when equipment is stopped during driving of a motor, a large current flows to the contact points of a switch (for example, a relay), and abnormality (failure) such as the contact points of the switch (for example, a relay) being welded may occur. Alternatively, abnormality (failure) may occur such as a coil of the switch (for example, a relay) disconnecting for some factors.

If a motor is driven in a case where abnormality occurs in such a dynamic braking circuit, the switch remains in a closed state, and terminals of the motor remain short-circuited via a resistor. For this reason, the drive current of the motor flows in the resistor, which may possibly lead to damage to the resistor.

The present invention has an object of providing a motor drive device that detects abnormality of a dynamic braking circuit.

(1) A motor drive device (for example, a motor drive device 1 described above) according to the present invention is a motor drive device that inputs AC power (AC electric power) from a power supply (for example, an AC power supply 2 described later) and drives a motor (for example, a motor 3 described later) used in equipment, the motor drive device including: a converter (for example, a converter 11 described later) configured to convert the AC power from the power supply into DC power (DC electric power); an inverter (for example, an inverter 12 described later) configured to convert the DC power from the converter into AC power and supply the AC power to the motor; a DC link capacitor (for example, a DC link capacitor 13 described later) provided at a DC link unit between the converter and the inverter; a dynamic braking circuit (for example, a dynamic braking circuit 20 described later) including a resistor (for example, a resistor 21 described later) and a switch (for example, a switch 22 described later) provided between terminals of the motor, the dynamic braking circuit being configured to perform braking of the motor by establishing the switch in an open state to disconnect between the terminals of the motor when driving the motor, and short-circuiting the terminals of the motor via the resistor with the switch in a closed state when stopping the motor (3); current detectors (for example, a current detector 41, 42 described later) configured to detect drive current of the motor; and an abnormality detector (for example, abnormality detector 30 described later) configured to detect, when driving the motor, abnormality of the dynamic braking circuit on a basis of a slope of a rise or a fall of the drive current of the motor detected by the current detector.

(2) The motor drive device described in (1) may further include a storage unit (for example, a storage unit 35 described later) configured to store, in advance, a threshold value for detecting the abnormality of the dynamic braking circuit, in which the abnormality detector may detect the abnormality of the dynamic braking circuit in a case in which an absolute value of the slope of the rise or the fall of the drive current of the motor detected by the current detector is equal to or greater than the threshold value.

(3) In the motor drive device described in (1) or (2), the switch in the dynamic braking circuit may be an electromagnetic contact-type relay that is configured with a contact point and a coil, and the abnormality of the dynamic braking circuit may be welding of the contact of the switch or disconnection of the coil of the switch.

(4) In the motor drive device described in any one of (1) to (3), the equipment may include a control device that generates an operating command and an amplifier that generates a control signal of the motor drive device for controlling the motor on a basis of the operating command from the control device, and the abnormality detector may be provided at the amplifier.

According to the present invention, it is possible to provide a motor drive device that detects abnormality of a dynamic braking circuit.

### BRIEF DESCRIPTION OF THE DRAWINGS

FIG. 1 is a diagram illustrating a circuit configuration of a motor drive device according to the present embodiment;

FIG. 2 is a diagram illustrating the motor drive current in a case of a motor being driven when a dynamic braking circuit in the motor drive device illustrated in FIG. 1 operates normally;

FIG. 3 is a diagram illustrating the motor drive current in a case of a motor being driven when a dynamic braking circuit in the motor drive device illustrated in FIG. 1 operates abnormally;

FIG. 4 is a schematic diagram illustrating the motor drive current in a case of a motor being driven when a dynamic braking circuit in the motor drive device illustrated in FIG. 1 operates normally and when operating abnormally; and

FIG. 5 is a schematic diagram illustrating the motor drive current in a case of a motor being driven when a dynamic braking circuit in the motor drive device illustrated in FIG. 1 operates normally and when operating abnormally.

### DETAILED DESCRIPTION OF THE INVENTION

In the following, an example of an embodiment of the present invention will be described with reference to the attached drawings. It should be noted that the same reference symbols will be attached to identical or corresponding portions in the respective drawings.

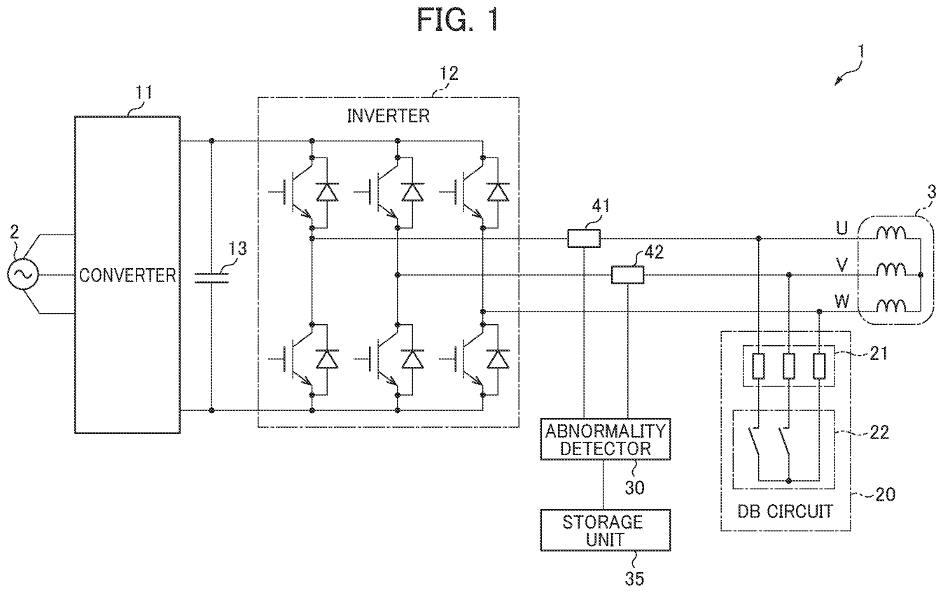

FIG. 1 is a diagram illustrating the circuit configuration of a motor drive device according to the present embodiment. The motor drive device 1 illustrated in FIG. 1 is a device that drives a motor 3 used for a machine (equipment) such as a machine tool, industrial machine, or a robot.

Such a machine (equipment) includes a numerical control device that generates an operating command, and an amplifier (for example, serve amplifier) that generates a control signal of the motor drive device 1 on the basis of the operating command from the numerical control device and controls the motor 3.

The motor drive device 1 inputs three-phase AC (alternating-current) power from a commercially three-phase AC power supply 2 to thereby drive the motor 3, on the basis of the control signal from the amplifier in the equipment, for example.

The motor drive device 1 includes a converter 11, an inverter 12, a DC link capacitor 13, a dynamic braking circuit (DB circuit) 20, an abnormality detector 30, a storage unit 35, and current detectors 41 and 42.

The converter 11 converts the AC power derived from the AC power supply 2 into DC power. The converter 11 is configured with a PWM converter or a diode rectifying converter including power semiconductor elements and bridge circuits consisting of diodes connected in reverse parallel to the power semiconductor elements.

The inverter 12 converts DC power from the converter 11 into AC power and supplies the AC power to the motor 3. The inverter 12 is configured with power semiconductor elements and a bridge circuit having diodes connected in a reverse parallel to the power semiconductor elements. The inverter 12 performs ON-OFF control (for example, PWM control) on these power semiconductor elements according to commands from a controller (not shown), thereby converting DC voltage to AC voltage with a desired waveform and frequency.

Furthermore, the inverter 12 converts AC power regenerated from the motor 3 into DC power, and supplies this DC power to a DC link unit provided between the inverter 12 and the converter 11.

A DC link capacitor 13 is provided at the DC link unit provided between the converter 11 and the inverter 12. The DC link capacitor 13 accumulates DC power from the converter 11 and DC power (regenerative power) from the inverter 12. Furthermore, the DC link capacitor 13 smoothes the DC voltage converted by the converter 11 or the inverter 12.

The dynamic braking circuit 20 performs braking of the motor 3 for quickly stopping the motor 3 when stopping the equipment. The dynamic braking circuit 20 is configured from three resistors 21 and two switches 22 provided between the terminals of the motor 3 (in other words, between the phases of the motor coil). In FIG. 1, the switch 22 is provided to the respective two terminals, which are a U-phase terminal and a V-phase terminal, among the U-phase terminal, the V-phase terminal, and a W-phase terminal. However, the switch 22 may be provided to at least two terminals among the U-phase terminal, the V-phase terminal, and the W-phase terminal. In other words, the switch 22 may be provided also to the W-phase terminal.

Examples of the switch 22 include a mechanical contact relay such as a b-contact electromagnetic contact-type relay (normally-closed: open when current flows in a coil)).

When driving the motor 3, the switch 22 is established in an open state. This causes the dynamic braking circuit 20 to disconnect between the terminals of the motor 3. On the contrary, when stopping the equipment during the driving of the motor 3 (in other words, when the motor 3 is stopped, i.e., when stopping the motor 3), the switch is set to be in a closed state in accordance with the control signal from the amplifier, for example. The dynamic braking circuit 20 thereby short-circuits the terminals of the motor 3 via the resistor 21 and consumes, as heat, rotational energy of the motor 3, thereby performing braking of the motor 3.

Furthermore, during the equipment being stopped (in other words, during the motor 3 being stopped), the switch 22 maintains the closed state in accordance with the control signal from the amplifier, for example. The dynamic braking circuit 20 to perform braking on power generation of the motor 3 due to any external power (power generation braking control of the motor).

Here, in a case in which the dynamic braking circuit 20 is activated when the equipment is stopped during the driving of the motor 3, for example, a large current flows in the contact points of the switch 22 (for example, a relay) and abnormality (failure) such as the contact points of the switch 22 (for example, a relay) being welded may occur. Alternatively, abnormality (failure) may occur such as a coil of the switch 22 (for example, a relay) disconnecting for some factors.

In a case in which the motor 3 is activated when the abnormality of such a dynamic braking circuit 20 occurs, the switch 22 remains in the closed state, and the terminals of the motor 3 also remain short-circuited via the resistor 21. For this reason, the drive current of the motor 3 flows in the resistor 21, which may possibly lead to damage to the resistor 21.

In general, a motor drive device has an over current detection function; however, since there may be a case in which current does not exceed the threshold of overcurrent detection, depending on a resistance value of the resistor 21 of the dynamic braking circuit 20, it may not be possible to detect the abnormality of the dynamic braking circuit 20 (abnormality of welding of the switch or abnormality of disconnection of the coil).

Therefore, the present embodiment includes, for example, the current detectors 41 and 42, the abnormality detector 30, and the storage unit 35.

The current detectors 41 and 42 detect the drive current of the motor 3. In FIG. 1, the current detectors 41 and 42 are respectively provided to the U-phase terminal and the V-phase terminal, among the U-phase terminal, V-phase terminal, and W-phase terminal. However, the current detectors 41 and 42 may be provided to at least two terminals among the U-phase terminal, the V-phase terminal, and the W-phase terminal.

The current detectors 41 and 42 are not particularly limited but may be shunt resistors that are serially connected between the inverter 12 and the motor 3. In such a case, the drive current of the motor 3 is detected on the basis of the voltage at both ends of the shunt resistor. Furthermore, when the drive current of the motor 3 is relatively large, the current detectors 41 and 42 may be Hall elements.

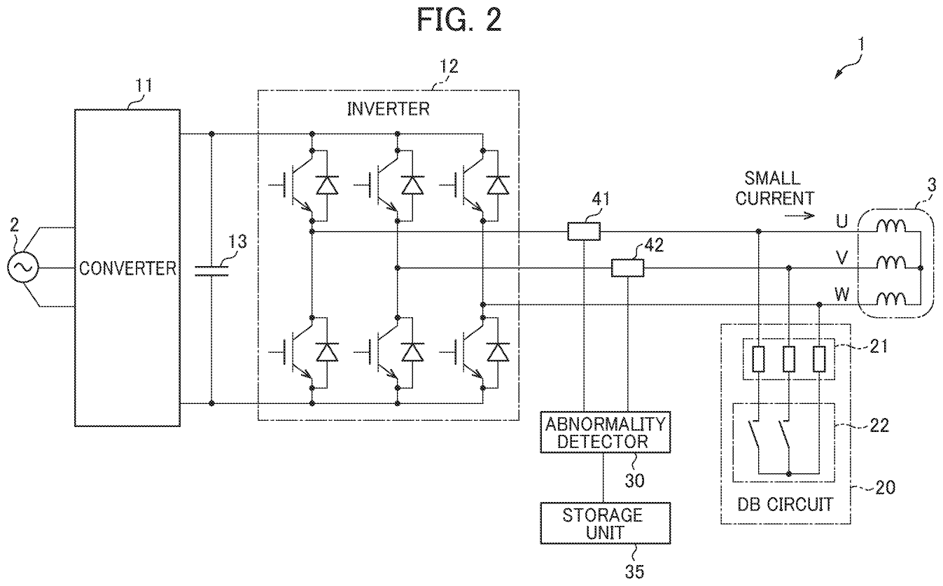

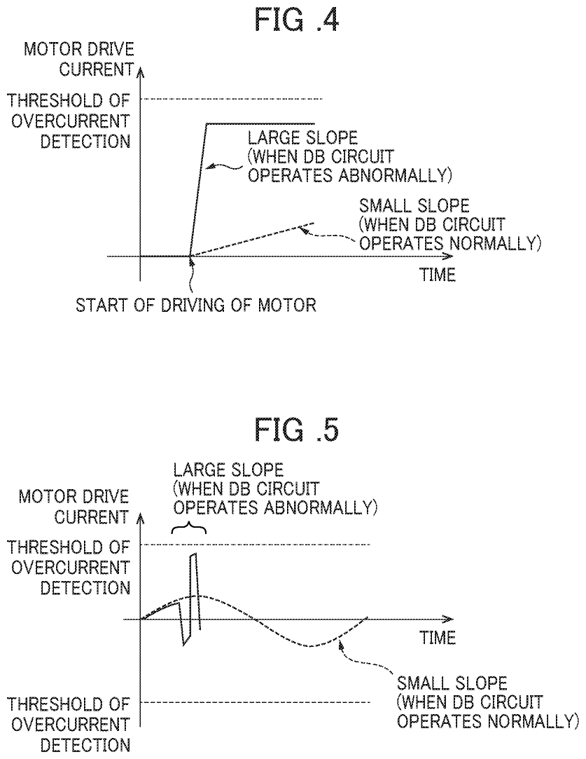

Here, as illustrated in FIG. 2, in a case in which the switch 22 of the dynamic braking circuit 20 operates normally and is established in an open state (when the DB circuit operates normally), the drive current of the motor 3 (in other words, an output current of the inverter 12 for driving the motor 3) flows in the motor 3. In such a case, as illustrated in FIG. 4, due to the inductance of the motor 3, the slope of the rise of the drive current of the motor 3 detected by the current detectors 41 and 42 (for example, when the driving of the motor 3 is started) is small. Furthermore, as illustrated in FIG. 5, the slope of the rise or the fall of the drive current of the motor 3 detected by the current detectors 41 and 42 (for example, during the driving of the motor 3 such as when the motor 3 accelerates or decelerates) is small.

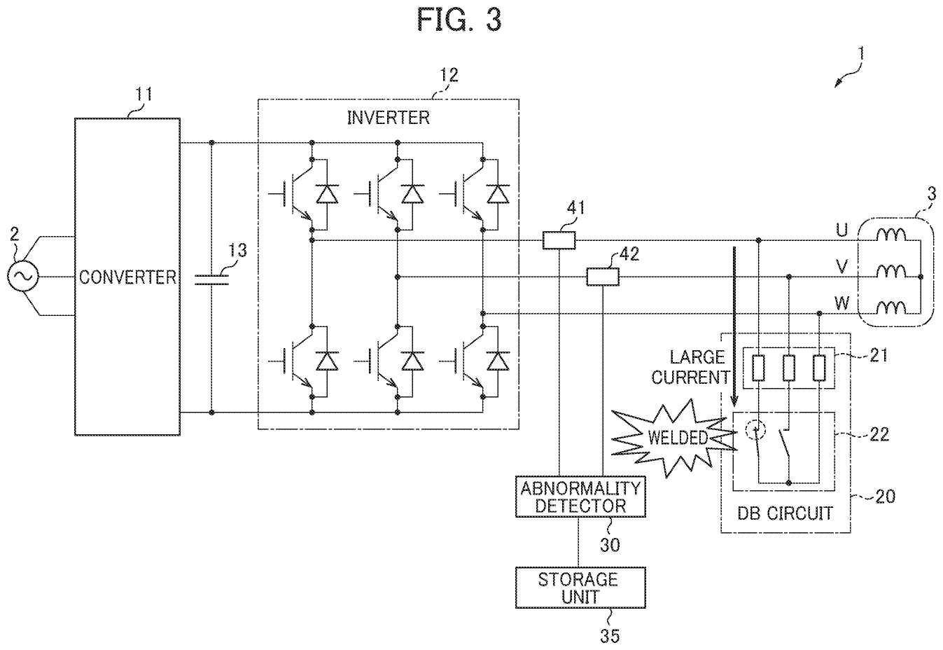

On the contrary, as illustrated in FIG. 3, in a case in which the contact points of the switch 22 of the dynamic braking circuit 20 is welded or the coil of the switch 22 is disconnected (when the DB circuit operates abnormally), the drive current of the motor 3 (in other words, output current of the inverter 12 for driving the motor 3) flows in the dynamic braking circuit 20. In such a case, the inductance of the dynamic braking circuit 20 is smaller than the inductance of the motor 3, as illustrated in FIG. 4, the slope of the rise of the drive current of the motor 3 detected by the current detectors 41 and 42 (for example, when the driving of the motor 3 is started) is relatively large. Furthermore, as illustrated in FIG. 5, the slope of the rise or the fall of the drive current of the motor 3 detected by the current detectors 41 and 42 (for example, during the driving of the motor 3 such as when the motor 3 is accelerated or decelerated) is relatively large.

It should be noted that, since the current flowing in the dynamic braking circuit 20 is restricted by the resistor 21, it does not rise up to the threshold value of over current detection.

The storage unit 35 stores, in advance, a threshold value for detecting abnormality of the dynamic braking circuit 20. More specifically, the storage unit 35 stores, in advance, a threshold (absolute value) for the slope of the rise or the fall of the drive current of the motor 3. The storage unit 35 is, for example, rewritable memory such as EEPROM. Furthermore, the storage unit 35 stores predetermined software (programs) for realizing various types of functions of the abnormality detector 30.

The abnormality detector 30 detects, when driving the motor 3, abnormality of the dynamic braking circuit 20 (abnormality of welding in the switch or abnormality of disconnection in the coil) on the basis of the slope of the rise or the fall of the drive current of the motor 3 detected by the current detectors 41 and 42. More specifically, the abnormality detector 30 detects abnormality in the dynamic braking circuit 20 (abnormality of welding in the switch or abnormality of disconnection in the coil) in a case in which an absolute value of the slope of the rise or the fall of the drive current of the motor 3 detected by the current detectors 41 and 42 is equal to or greater than a threshold value stored in the storage unit 35.

The abnormality detector 30 is configured with an arithmetic processor such as DSP (Digital Signal Processor) and FPGA (Field-Programmable Gate Array). The functions of the abnormality detector 30 are realized by executing the predetermined software (programs) stored in the storage unit 35. The functions of the abnormality detector 30 may be realized in cooperation with hardware and software, or may be realized with only hardware (electronic circuit).

As described above, according to the motor drive device 1 of the present embodiment, it is possible to detect, when driving a motor, abnormality of the dynamic braking circuit 20 (abnormality of welding in a switch or abnormality of disconnection in a coil) by employing the difference in the slope of the rise or the fall of the drive current of the motor 3 when the dynamic braking circuit 20 operates normally and abnormally (abnormality of welding in the switch or abnormality of disconnection in the coil).

Incidentally, as a method of detecting abnormality of the dynamic braking circuit 20 (abnormality of welding in a switch or abnormality of disconnection in a coil), a method is assumed in which contact points for confirming the operation of a relay serving as the switch 22 is used or a temperature of the resistor 21 is measured. In such a case, an additional circuit is required.

With regard to this, in the present embodiment, the abnormality detector 30 or the storage unit 35 may be provided to an amplifier in the equipment. With such a configuration, it is possible to realize the abnormality detector 30 and the storage unit 35 with an existing arithmetic processor and memory in the amplifier, which eliminates the need for providing an additional circuit in the motor drive device 1 and the amplifier. Furthermore, compared to the case in which the abnormality detector 30 and the storage unit 35 are provided to a numerical control device for the equipment, it is possible to promptly detect the abnormality of the dynamic braking circuit 20.

Although an embodiment of the present invention is described above, the present invention is not limited to the abovementioned embodiment, and various modifications and variations are possible. For example, in the abovementioned embodiment, the motor drive device 1 that inputs three-phase AC power to thereby drive the motor 3 is exemplified. However, the features of the present invention are not limited thereto, and, for example, can be applied to a motor drive device that inputs single-phase alternating current to drive the motor 3.

Furthermore, the abovementioned embodiment exemplifies the motor drive device 1 including the dynamic braking circuit 20 made using a mechanical contact relay such as a b-contact electromagnetic contact-type relay as the switch 22. However, the features of the present invention are not limited thereto, and, for example, can be applied to a motor drive device including a dynamic braking circuit using various kinds of switches such as a semiconductor element.

### EXPLANATION OF REFERENCE NUMERALS

1 motor drive device
2 AC power supply
3 motor
11 converter
12 inverter
13 DC link capacitor
20 dynamic braking circuit (DB circuit)
21 resistor
22 switch
30 abnormality detector
35 storage unit
41, 42 current detector

What is claimed is:

1. A motor drive device that inputs AC power from a power supply and drives a motor used in equipment, the motor drive device comprising:
a converter converting the AC power from the power supply into DC power;
an inverter converting the DC power from the converter into AC power and supplying the AC power to the motor;
a DC link capacitor provided at a DC link unit between the converter and the inverter;
a dynamic braking circuit including a resistor and a switch provided between terminals of the motor, the dynamic braking circuit performing braking of the motor by establishing the switch in an open state to disconnect between terminals of the motor when driving the motor, and short-circuiting the terminals of the motor via the resistor with the switch in a closed state when stopping the motor;
a current detector detecting drive current of the motor; and
an abnormality detector detecting, when driving the motor, abnormality of the dynamic braking circuit on a basis of a slope of a rise or a fall of the drive current of the motor detected by the current detector.

2. The motor drive device according to claim 1, further comprising a storage unit storing, in advance, a threshold value for detecting the abnormality of the dynamic braking circuit, wherein
the abnormality detector detects the abnormality of the dynamic braking circuit in a case in which an absolute value of the slope of the rise or the fall of the drive current of the motor detected by the current detector is equal to or greater than the threshold value.

3. The motor drive device according to claim 1, wherein the switch in the dynamic braking circuit is an electromagnetic contact-type relay that is configured with a contact point and a coil, and
the abnormality of the dynamic braking circuit includes welding of the contact point of the switch or disconnection of the coil of the switch.

4. The motor drive device according to claim 1, wherein the equipment includes a control device that generates an operating command and an amplifier that generates a control signal of the motor drive device for controlling the motor on a basis of the operating command from the control device, and
the abnormality detector is provided at the amplifier.
